(19) United States
(12) Patent Application Publication
(10) Pub. No.: US 2015/0330019 A1
(43) Pub. Date: Nov. 19, 2015

(54) Biocatalytic hydrophilization of polyolefines

(71) Applicant: BASF SE, LUDWIGSHAFEN (DE)

(72) Inventors: EVA ALMANSA, GRAZ (AT); ARTUR CAVACO-PAULO, BRAGA (PT); HARALD CHROBACZEK, AUGSBURG (DE); ANITA EBERL, GRAZ (AT); ANTON GLIEDER, GLEISDORF (AT); GEORG GUBITZ, GRAZ (AT); ANDREA HASMANN, GRAZ (AT); SONJA HEUMANN, GRAZ (AT); RULE NIEDERSTADT, AUGSBURG (DE); KAI-UWE SCHOENING, OBERWIL (CH)

(73) Assignee: BASF SE, LUDWIGSHAFEN (DE)

(21) Appl. No.: 14/281,088

(22) Filed: May 19, 2014

(51) Int. Cl. D06M 15/15; D06P 3/79

(52) U.S. Cl. CPC D06M 15/15; D06P 3/79; C12Y 113/00; C12Y 114/00; C08F 10/06

(57) ABSTRACT

A new process for enhancing the hydrophilicity of the surface of a polyolefin or polyolefin copolymer article is characterized in that the surface is treated with an enzyme selected from oxidoreductases, especially of the cytochrome P450 family or enzymes classified as EC 1.13 or EC 1.14. The process is especially useful for the treatment of polypropylene films, fibres, or fabrics, inter alia for use in sanitary articles, threads, yarns, fabrics, textiles, garments, technical or household articles, printed or dyed cover films or packaging films.

This application is a Divisional of U.S. Ser. No. 12/309,547, filed Sep. 3, 2009, which is a national stage filing of International Application No. PCT/EP 2007/057357, filed Jul. 17, 2007 all herein incorporated entirely by reference.

This application pertains to a process for enhancing the hydrophilicity of the surface of a polyolefin or polyolefin copolymer article by treatment with a selected enzyme, to polymer articles obtainable according to this process, to the use of an oxidoreductase for enhancing the hydrophilicity of the surface of a polyolefin or polyolefin copolymer article, and to the use of a polymer article obtained according to the invention for certain applications requiring a hydrophile surface.

Though polyolefins and polyolefin copolymers belong to the most widely used polymers, their use in many applications is still restricted due to the low hydrophilicity or wettability of surfaces or fabrics made thereof. Especially the use of these polymers as substrates for printing or writing, or for textiles, still is limited to applications where hydrophilicity is not, or only to a minor extent, required. Polyproplylene, for example, is a very versatile polymer and has a lot of advantages compared to other polymers. It is chemically inert, heat resistant and light weighted. PP-fibres are often used for functional sportswear due to the extreme hydrophobicity of the surface. Water cannot be absorbed. Thermoplastic polypropylene fibres, which are typically extruded at temperatures in the range of from about 210° to about 240° C., are inherently hydrophobic in that they are essentially non-porous and consist of continuous molecular chains incapable of attracting or binding to water molecules. As a result, untreated polypropylene fabrics, even while having an open pore structure, tend to resist the flow of polar liquids such as water or urine through the fabric, or from one surface to the other.

There is a big industrial demand to improve moisture uptake, dyeability and the fastness of special finishes. For this purpose, hydroxyl groups could be inserted. Although the potential of physical/chemical methods for the hydrophilisation of polyolefin based materials has been assessed (see, for example, WO 02/42530, or publications cited therein), none of these techniques has reached industrial application yet.

Recently it has been shown that enzymes can be used for targeted surface functionalisation of a number of synthetic polymers such as polyacrylonitrile, polyethylene terephthalate and polyamide. These processes are based on partial enzymatic hydrolysis of nitrile groups (e.g. Wang et al., AATCC Review 4, 28-30 (2004)), ester bonds (Fischer-Colbrie et al., Biocatal. Biotrans. 22, 341-346 (2004); Alisch et al., Biocatal. .Biotrans. 22, 347-351 (2004); Vertommen et al., J. Biotechnol. 120:376-386 (2005); WO 01/14629), and amide bonds (Silva et al., J. Polym. Sci. Part A: Polym. Chem. 43, 2448-2450 (2005)) on the surface of these polymers. Thereby the hydrophilicity of the polymers is increased, with many beneficial effects on further finishing and functionalisation. In contrast to chemical/physical processes, the enzymatic treatment may be carried out under mild conditions (e.g. near neutral pH, near ambient temperature) and does not discharge harmful substances into the environment. Furthermore, due to the size of enzymes, the reaction is targeted to the surface, generally avoiding internal modifications, which could lead to strength losses and/or other adverse effects.

EP-A-687729 discloses a method for coating a cellulosic or synthetic fiber with an enzyme crosslinked on the fiber surface, inter alia to improve hydrophilicity.

There is a need for an enzymatic process for the modification, rather than coating, of surfaces mainly made up from hydrocarbon polymers such as polyolefins or polyolefin copolymers.

It has now been found that the surface hydrophilicity of polyolefin or polyolefin copolymer articles may conveniently and efficiently be enhanced, mainly by modification of a polyolefin surface, using a certain class of enzymes.

First of all, therefore, the present invention pertains to a process for enhancing the hydrophilicity of the surface of a polyolefin or polyolefin copolymer article, characterized in that the surface is treated with an enzyme selected from oxidoreductases.

A polyolefin or polyolefin copolymer article in the above sense is to be understood as an object, such as a fiber, textile, nonwoven, fabric, film or sheet (see below for further types of articles, their use or preparation as far as relevant for the present invention), whose surface or outer surface layer comprises a polyolefin or polyolefin copolymer (see below for preferred components and amounts thereof).

Oxidoreductases as well as the preferred monooxygenases among them are known components; they can be obtained from bacterial, yeast, plant and fungal sources as well as from mammalian cells; whole cells may be used (e.g. lyophilized cells), or the enzyme in isolated form. Cell preparations or isolated/recombinant enzymes are widely known, many are commercially available.

In particular, the enzymes used may belong to the class of oxidoreductases as classified as EC 1, and more specifically to enzymes acting on single donors with incorporation of molecular oxygen as classified as EC 1.13 and enzymes acting on paired donors, with incorporation or reduction of molecular oxygen as classified as EC 1.14.

The abbreviation “EC” stands for “Enzyme Commission number”, a numerical classification scheme of enzymes based on the chemical reaction catalysed by the enzyme issued by the Nomenclature Committee of the International Union of Biochemistry and Molecular Biology (NC-IUBMB).

Enzymes of the present classes are well known and defined in literature (Cirino et al., 2002). The enzyme may be obtained or derived from any origin including bacterial, fungal, yeast, plant or mammalian origin. The enzyme can be used as cell lysate or the enzyme maybe purified which means that it is free from any other components produced from the organisms from which it is derived. The enzyme can be used in any form such as a dry powder, granulate, liquid or stabilising liquid. In addition to the enzyme, the incubation mixture may contain cofactors such as NADPH or NADH, cofactor regenerating systems, a buffer and surfactants. Additionally chemicals improving the interaction between enzyme and substrate such as wetting or dispersing agents may be contained.

Monooxygenases, including cytochrome P450 proteins (named for the absorption band at 450 nm of their carbon monoxide bound form) are an especially suitable family of enzymes. P450s are ubiquitous enzymes involved e.g. in the utilization of carbon compounds as an energy source in bacteria, or in the production of various macrolide antibiotics; in mammals these enzymes are involved in synthesis and breakdown of hormones and detoxification of various compounds such as drugs and toxic substances. P450s often use electrons from another source (such as the cofactor NADPH) to catalyze activation of molecular oxygen, leading to regiospecific and stereospecific hydroxylation of non-activated hydrocarbons at physiological conditions.

The process can be carried out at mild conditions in terms of pH and temperatures and does not discharge harmful substances into the environment. The enzyme treatment of the surfaces may be carried out under conditions suitable for the selected enzyme according to well known principles. In many cases, an additional additive such as a surfactant and/or an electron mediating system such as a reducing agent (such as NADP, NADPH, or other suitable substances) or substrate, is used concomitantly. It is also possible to use an electron mediating system employing an external electron source. The amount of enzyme, treatment time, temperature, pH value and optional additive may be varied according e.g. to the specific enzyme selected and to the extent of modification required. These treatment conditions may be optimized according to well known procedures.

The enzyme may be used, for example, in amounts from 0.001 g to 10 g/kg enzyme protein, each per kg of polymer material to be treated, especially in case of fibres; alternatively, the amount of enzyme often ranges from 10⁻⁵ to 0.1 g of enzyme protein per square meter of surface to be treated, especially for films or bulk materials such as extruded or moulded articles. The enzyme treatment is preferably carried out at a temperature ranging from 30° C. to 100° C. The pH value of the incubation mixture may depend on the selected enzyme and range from 3 to 12, more preferably from pH 5 to 9. Especially preferred is a neutral pH near pH 7, e.g. pH 6-pH 8. A suitable reaction time usually is more than 10 seconds, it may range from 10 to about 30000 seconds, often from 5 minutes to 10 hours. Since the enzyme usually is removed directly after the treatment to uncover the polymer surface thus modified, the process may additionally comprise a rinsing step, e.g. with dilute alkali or aqueous solutions of pH>8. Although residuents of materials used during the present process, e.g. residual enzyme, usually do not play negative effects on the desired result, any steps leading to fixation of such a material, such as chemical bonding or crosslinking, usually are avoided.

Aqueous solutions can be pure water or (preferably) buffered water solutions, or may be mixtures of water or water buffer with an organic solvent; generally suitable are all inert organic solvents, especially those miscible or partly miscible with water, e.g. those solvents showing miscibility with at least 1% by weight of water in the temperature range 30-100° C. The organic solvent usually is of lower polarity than water; examples are slightly polar hydrocarbons such as toluene, alcohols, ethers etc. as well as solvent mixtures. The reaction can be carried out in a homogeneous system or in multi phase systems, e.g. using 2 phases of solvent and/or a carrier-bound enzyme.

The treatment with the present enzyme or enzymes often leads to the incorporation of oxygen into the polyolefin, especially polypropylene, based materials. The enzyme treatment thus increases hydrophilicity and inserts anchor points for further functionalisation of these materials.

The effect of the treatment of the invention may be assessed according to methods known in the art (see also examples below). Hydrophilicity of the surface achieved according to the present invention usually results in a contact angle to water, which is at least 10° smaller than the one of the untreated surface. Contact angle reduction often is much higher, e.g. reduction of the contact angle to water by 25% or more, preferably by 50% or more, more preferably 80% or more, or even 90% or more.

The process may include additional finishing steps such as dyeing, printing, imparting antimicrobial or flame-retardant properties, antistatic properties by application of one or more suitable agents.

The use of some polymeric as well as oligomeric substances that are commonly used in the textile industries, may further help to improve the durability of the properties of the textile. Such substances include, but are not limited to, resin finishings that provide easy care and/or other properties to various textile materials, softeners, coating materials, fixation agents and/or other finishing agents such as hydrophilic and hydrophobic agents, flame retardants etc.

For example, a textile material or fabric treated according the present invention before the dyeing of the textile or fabric, and dyeing and optional further steps such as application of a light protecting agent, a sun protection factor (SPF) enhancing agent and/or an antimicrobial follow as an after-treatment. The application of dye or further agent can, for example, be carried out by an exhaustion process, padding, spraying or by foam application, often using aqueous formulations which additionally comprise a small amount of an organic solvent, a surfactant, a dispersant, and/or an emulsifier.

Padding can be carried out according to conventional padding processes. For example, the textile material is passed through an aqueous liquor comprising the dye or agent, the textile material is squeezed to a defined liquor pick-up rate and then a fixation step is carried out, preferably a heat treatment. This is usually carried out as a continuous process wherein the textile material is continuously passed through the aqueous liquor containing the dye and/or agent.

The fixation step is usually carried out by a heat treatment, for example at a temperature of 60 to 150° C., especially 90 to 150° C.

The exhaustion process is usually carried out from an aqueous liquor, at a pH value of from 2 to 9, from 4 to 7, and a temperature from 50 to 100° C. and especially from 80 to 100° C. The liquor ratio selected can vary within a wide range, for example from 1:5 to 1:50, preferably from 1:5 to 1:30.

Spraying can be carried out according to conventional spraying processes. According to these processes aqueous liquids comprising the agent to be applied are sprayed onto the textile material. The amount of agent in the aqueous liquor often is 0.001% to 10% by weight, especially 0.01% to 10% by weight, based on the weight of the aqueous liquor, depending on type of agent. Such spraying processes are especially suitable for applying the further agents such as an antimicrobial or antistatic agent to textile materials like carpets. According to such preferred processes a plurality of spray nozzles are disposed in a spray line transverse to the direction of movement of, for instance, the carpet. The agent is applied as an aqueous liquor by the spray nozzles, for example by virtue of pressure.

After spraying, usually a fixation step is carried out, which can be performed by a heat treatment as given above for the padding process.

The additional agent can also be applied to the textile material by foam application. As to this application all of the above conditions and preferences given above for the spraying process apply. However, the agent is applied in form of an aqueous foam which usually contains a foam stabiliser and may comprise other customary additives. Such a process is also especially suitable for treating carpets.

Exhaustion, padding, spraying or foam applications can be carried out by applying the desired agent to the textile material together with dyestuffs (for example in a dyeing process) or in other textile related processes, like finishing processes.

For such processes the above conditions and preferences apply. Suitable dyes are disperse dyes, basic dyes, acid dyes, direct dyes or reactive dyes. Reactive dyes are especially suitable for natural polyamide- or cellulose-containing textile materials. Direct dyes are especially suitable for cellulose-containing textile materials. The dyes may belong to different dye classes, including acridone, azo, anthraquinone, coumarin, formazane, methine, perinone, naphthoquinone-imine, quinophthalone, styryl or nitro dyes. Mixtures of dyes may also be used.

After the dyeing process optionally including the application of a further agent, the textile material can be subjected to a fixation step, like a heat treatment as given above.

The polyolefin or polyolefin copolymer material may be a fibre, fabric, nonwoven, mono- or biaxially stretched film, or a moulded or extruded article. Polyolefins or polyolefin copolymers useful for treatment according to the present process include the following polymers:

1. Polymers of monoolefins and diolefins, for example polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different, and especially by the following, methods:
a) radical polymerisation (normally under high pressure and at elevated temperature).
b) catalytic polymerisation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either π- or α-coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethyleneacrylic acid copolymers (EAA), LLDPE/EVA, LLDPE/EAA and alternating or random polyalkylene/carbon monoxide copolymers and mixtures thereof with other polymers, for example polyamides.

4. Hydrocarbon resins (for example C₅-C₉) including hydrogenated modifications thereof (e.g. tackifiers) and mixtures of polyalkylenes and starch.

Homopolymers and copolymers from 1.)-4.) may have any stereostructure including syndiotactic, isotactic, hemi-isotactic or atactic; where atactic polymers are preferred. Stereoblock polymers are also included.

5. Polystyrene, poly(p-methylstyrene), poly(α-methylstyrene).

6. Aromatic homopolymers and copolymers derived from vinyl aromatic monomers including styrene, α-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred. Stereoblock polymers are also included.

6a. Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.

6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).

6c. Hydrogenated aromatic polymers derived from hydrogenation of polymers mentioned under 6a.).

Homopolymers and copolymers may have any stereostructure including syndiotactic, isotactic, hemi-isotactic or atactic; where atactic polymers are preferred. Stereoblock polymers are also included.

Preferred among these are groups 1-3, especially polyethylene, polypropylene, or blends and/or copolymers thereof.

The surface to be treated (and usually the underlying material) usually is made up by at least 10%, for example at least 30%, and preferably at least 50% of repeating units resulting from olefin polymerization. Preferred are materials containing a majority of polyolefinic materials (such as of groups 1-3 above), e.g. 80-100% by weight of the polymers, with an optional content of one or more modifier resins.

Most preferably, the surface material of the article is composed of polypropylene or a blend and/or copolymer, wherein propylene repeating units make up at least 10%, for example at least 30%, and preferably at least 50% of the repeating units.

In addition, the present material, such as polyolefin fibres, filaments and fabrics, may contain customary additives, fillers and/or finishing agents such as dyes, pigments, process stabilizers, light stabilizers such as ultraviolet light absorbers and/or hindered amine light stabilizers, antioxidants, processing aids and other additives.

For example, the polyolefin or polyolefin copolymer articles treated according to the invention may optionally also contain from about 0.01 to about 10%, preferably from about 0.025 to about 5%, and especially from about 0.1 to about 3% by weight of various conventional stabilizers or additives, such as the materials listed below, or mixtures thereof.

### 1. Antioxidants:

1.1. Alkylated monophenols, for example 2,6-di-tert-butyl-4-methylphenol,
1.2. Alkylthiomethylphenols, for example 2,4-dioctylthiomethyl-6-tert-butylphenol,
1.3. Hydroquinones and alkylated hydroquinones, for example 2,6-di-tert-butyl-4-methoxyphenol, 2,5-di-tert-butylhydroquinone,
1.4. Tocopherols, for example α-tocopherol,
1.5. Hydroxylated thiodiphenyl ethers, for example 2,2′-thiobis(6-tert-butyl-4-methylphenol),
1.6. Alkylidenebisphenols, for example 2,2′-methylenebis(6-tert-butyl-4-methylphenol),
1.7. O-, N- and S-benzyl compounds, for example 3,5,3′,5′-tetra-tert-butyl-4,4′-dihydroxydibenzyl ether,
1.8. Hydroxybenzylated malonates, for example dioctadecyl-2,2-bis(3,5-di-tert-butyl-2-hydroxybenzyl)malonate,
1.9. Aromatic hydroxybenzyl compounds, for example 1,3,5-tris(3,5-di-tert-butyl-4-hydroxybenzyl)-2,4,6-trimethylbenzene,
1.10. Triazine compounds, for example 2,4-bis(octylmercapto)-6-(3,5-di-tert-butyl-4-hydroxyanilino)-1,3,5-triazine,
1.11. Benzylphosphonates, for example dimethyl-2,5-di-tert-butyl-4-hydroxybenzylphosphonate,
1.12. Acylaminophenols, for example 4-hydroxylauranilide,
1.13. Esters of β-(3,5-di-tert-butyl-4-hydroxyphenyl)propionic acid with mono- or polyhydric alcohols,
1.14. Esters of β-(5-tert-butyl-4-hydroxy-3-methylphenyl)propionic acid with mono- or polyhydric alcohols,
1.15. Esters of β-(3,5-dicyclohexyl-4-hydroxyphenyl)propionic acid with mono- or polyhydric alcohols,
1.16. Esters of 3,5-di-tert-butyl-4-hydroxyphenyl acetic acid with mono- or polyhydric alcohols,
1.17. Amides of β-3,5-di-tert-butyl-4-hydroxyphenyl)propionic acid e.g. N,N′-bis(3,5-di-tert-butyl-4-hydroxyphenylpropionyl)hexamethylenediamide,
1.18. Ascorbic acid (vitamin C),
1.19. Aminic antioxidants, for example N,N′-di-isopropyl-p-phenylenediamine.
2. UV absorbers and light stabilizers:
2.1. 2-(2′-Hydroxyphenyl)benzotriazoles, for example 2-(2′-hydroxy-5′-methylphenyl)-benzotriazole,
2.2. 2-Hydroxybenzophenones, for example the 4-hydroxy derivatives,
2.3. Esters of substituted and unsubstituted benzoic acids, for example 4-tert-butyl-phenyl salicylate,
2.4. Acrylates, for example ethyl α-cyano-β,β-diphenylacrylate,
2.5. Nickel compounds, for example nickel complexes of 2,2′-thio-bis[4-(1,1,3,3-tetramethylbutyl)phenol],
2.6. Sterically hindered amines, for example bis(2,2,6,6-tetramethyl-4-piperidyl)sebacate.
2.7. Oxamides, for example 4,4′-dioctyloxyoxanilide,
2.8. 2-(2-Hydroxyphenyl)-1,3,5-triazines, for example 2,4-bis(2,4-dimethylphenyl)-6(2-hydroxy-4-octyloxyphenyl [or-4-dodecyl/tridecyloxyphenyl])-1,3,5-triazine.
3. Metal deactivators, for example N,N′-diphenyloxamide.
4. Phosphites and phosphonites, for example triphenyl phosphite.
5. Hydroxylamines, for example N,N-dibenzylhydroxylamine.
6. Nitrones, for example, N-benzyl-alpha-phenylnitrone.
7. Thiosynergists, for example dilauryl thiodipropionate.
8. Peroxide scavengers, for example esters of β-thiodipropionic acid.
10. Basic co-stabilizers, for example melamine.
11. Nucleating agents, for example inorganic substances, such as talcum, metal oxides.
12. Fillers and reinforcing agents, for example calcium carbonate, silicates.
13. Other additives, for example plasticisers, lubricants, emulsifiers, pigments, rheology additives, catalysts, flow-control agents, optical brighteners, flameproofing agents, antistatic agents and blowing agents.
14. Benzofuranones and indolinones, for example those disclosed in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A-4316611; DE-A-4316622; DE-A-4316876; EP-A-0589839, EP-A-0591102; EP-A-1291384.

For more details on stabilizers and additives useful, see also list on pages 55-65 of WO 04/106311, which is hereby incorporated by reference.

The material may further contain hydrophilicity enhancing additives, such as disclosed in WO 02/42530.

The article to be treated according to the process of the invention may be, for example, a fibre, fabric, nonwoven, mono- or biaxially stretched film, or a moulded or extruded article. Preferred are polyolefin or polyolefin copolymer woven or nonwoven fibres that exhibit durable wettability. The fibres are useful inter alia in sanitary articles such as diapers, feminine hygiene products and incontinence care products.

The invention is also applicable to melt extruded bi-component fibres, wherein one of the components is a polyolefin according to this invention.

Non-woven fabrics of polyolefin may have a carded fibre structure or comprise a mat in which the fibres or filaments are distributed in a random array. The fabric may be formed by any one of numerous known processes including hydroentanglement or spun-lace techniques, or by air laying or melt-blowing filaments, batt drawing, stitchbonding, etc., depending upon the end use of the article to be made from the fabric.

Spunbond filament sizes most useful for wettable fabrics of the anticipated type are from about 1.0 to about 3.2 denier. Meltblown fibres typically have a fibre diameter of less than 15 microns and most typically for the anticipated applications are fibre diameters less than 5 microns, ranging down to the submicron level. Webs in a composite construction may be processed in a wide variety of basis weights.

The present invention is further aimed at woven or nonwoven fabrics, for example polypropylene fabrics. It is also aimed at threads or yarns for weaving or knitting in conventional textile processes.

The wettable fabrics produced from the fibres or filaments of this invention are particularly useful, for example, as the skin contacting inner lining fabric of sanitary articles, particularly single use diapers, training pants, feminine hygiene products or incontinence care products. The fabrics also have utility in technical or household articles e.g. as wet and dry wipes, wound dressings, surgical capes, filter medial, battery separators, and the like.

The structure of diapers are described for example in U.S. Pat. Nos. 5,961,504; 6,031,147 and 6,110,849, all incorporated herein by reference.

In addition, it is often desirable to impart wettability to melt extruded polyolefin films. Such films, in perforated form, are widely used as cover sheets for sanitary articles.

For coverstock for sanitary articles, improvements in wetback properties can be improved by the use of two or more layers of fabric bonded together.

The fabrics of the present invention may be sterilized by exposure to about 0.5 to about 10 megarads of gamma irradiation. Sterilization with gamma irradiation is employed for hospital garments and the like.

Polyolefin woven and nonwoven fibres and fabrics prepared according to the present invention also exhibit exceptional printability. As a result of their inherent hydrophobic nature, polyolefin fibres and fabrics may exhibit problems towards printability, that is standard printing techniques. The materials treated according to the present invention overcome these problems as well.

It is also contemplated that the materials of the present invention may be in the form of microporous membranes, perforated films, or nets. That is, other wettable polyolefin articles that are not fibres, filaments or fabrics.

The present invention also relates to a method for imparting permanent wettability to a polyolefin fibre, filament or woven or nonwoven fabric made therefrom, comprising treatment of a thermoplastic polyolefin after the forming step such as melt extruding into a plurality of fibres and cooling the fibres. Preferably said fibres are drawn into a plurality of continuous filaments, a web is formed from said filaments and the filaments are at least partially bonded to form a fabric. Preferably the fibres or filaments are a bi-component fibre or filament comprising a polyolefin.

The following test methods and examples are for illustrative purposes only and are not to be construed to limit the instant invention in any manner whatsoever. Room temperature (r.t.) depicts a temperature in the range 20-25° C.; over night denotes a time period in the range 12-16 hours. Percentages are by weight unless otherwise indicated.

Abbreviations used in the examples or elsewhere:

M concentration in moles per litre

w/v percentage given in g/ml (weight/volume)

DMSO dimethyl sulfoxide

Tris/HCl Tris(hydroxymethyl)aminomethane Hydrochloride (CAS No.: 1185-53-1)

### Rising Height (RH)

The determination of rising height (modified from DIN 53924) is used to quantify the increase in hydrophilicity due to enzyme treatment of polypropylene. Fabric test pieces of 4×6 cm are fixed on a rod affixed in vertical position directly above a water bath for measurement. One end of the test piece is immersed in the water for 1 cm. The water level on each test piece is detected 10 minutes after immersion, if not otherwise specified.

### Drop Test

A drop (20 μL of distilled water) is placed on the surface of the material. The time until the drop disappears is detected.

### Contact Angle to Water (CA)

Contact angle measurement is a characterization method of surface analysis related to surface energy and surface tension between a solid and a liquid drop. Contact angle describes the shape of a liquid drop resting on a solid surface and is defined as the angle between the tangent line (drawn from the drop shape to the touch of the solid surface) and the solid surface. The measurement provides information to study the bonding energy of the solid surface and surface tension of a liquid droplet and is a measure for the hydrophilicity of a surface.

### Carbon Monoxide (CO) Binding Assay for Quantification of P450 Enzyme

This method is used for quantification of functional P450-enzyme which contains the chromophoric heme-group. For the measurement, 3 mL of protein-solution (in Tris/HCl buffer, 30 mM, 1 M NaCl) are pipetted into a plastic tube. Ten μL of methyl viologen dichloride hydrate (1,1′-Dimethyl-4,4′-bipyridinium dichloride hydrate, CAS No. 1910-42-5); 1% (w/v) in distilled water) are added. This solution is used as a redoxindicator. Afterwards a small amount of sodium hydrosulfite is added. After mixing, the sample is separated into 2 portions. CO is bubbled through one of the samples for 1 minute (approximately 1 bubble per second). A spectrum is run from 390 nm to 500 nm. All spectral assays are carried out under aerobic conditions. The Cytochrome P450 concentration is determined according to the following formula 1.

$${c}_{P 450} = \frac{A ( 450 - 490 ) \times f \times 1000}{ɛ \times d} \qquad Formula 1$$

c concentration of enzyme in nmol/mL
A absorbance at 450 or 490 nm
f dilution factor
ε extinction coefficient, 91 [mM⁻¹ cm⁻¹]
d thickness of the cuvette, [cm]
1000 conversion from μmol/mL to nmol/mL

### Enzyme Production and Purification of P450 BM-3 Mutants

For the application examples described below, different monoxygenases from Bacillus megaterium are chosen as examples for bacterial enzymes incorporating oxygen into polyolefinic materials. Two different recombinant strains of E. coli DH5α containing P450 BM-3 wild type enzyme (NCBI J04832) and mutant 139-3 (Glieder et al., 2002) are cultivated as well as E. coli DH5α as a control. The thawed cells are suspended with 5 mL Tris-HCl buffer and then sonicated for 3 minutes. The crude suspension is centrifuged for 60 minutes at 18000 g. The resulting supernatant is diluted with buffer to a final volume of 25 mL and is then filtrated with a sterile filter (0.5 μm). Monooxygenases are purified by anion-exchange chromatography:

### Column: HiPrep® 16/10 QFF, 17 mL (Amersham Biosciences)

Flow rate: 5 mL/min
Eluent A: Tris/HCl buffer, 30 mM, pH 7.5
Eluent B: Tris/HCl buffer, 30 mM, pH 7.5, 1 M NaCl

A sample volume of 10 mL solution per run is used. Monooxygenase is detected during elution by continuously monitoring the absorbance at 280 nm (protein) and 417 nm (heme). The enzyme is eluted by increasing the NaCl-concentration. The most active fractions (brown coloured) are pooled and frozen at −20° C.

Enzyme Production with Beauveria bassiana

For the application examples described below, an enzyme preparation from Beauveria bassiana is chosen as example for fungal enzymes incorporating oxygen into polyolefinic materials. Cultures of Beauveria bassiana are harvested after 3 days of growth by filtration. The mycelium is sonyfied and treated with a cell homogenizer for 4 minutes. After centrifugation at 7000 rpm, the supernatant is filtrated and then frozen at −20° C.

### Enzyme Activity

Monooxygenase activity is measured based on the conversion of p-nitrophenoxyoctane to ω-oxyoctane and the chromophore p-nitrophenolate. The p-nitrophenolate formation is measured at 410 nm. After addition of 50 μL enzyme solution and 3 μL of a 50 mM solution of 8-pNA in DMSO to 910 μL potassium phosphate buffer (50 mM, pH 8.0), the reaction is started by addition of 30 μL of an aqueous solution of 6 mM NADPH. 940 μL of buffer is used as a reference.

$${A}_{8 \text{-} pNA} [ U \text{/} mL ] = \frac{Δ A * {f}_{1} * {f}_{2} * 1000}{ɛ * d} \qquad Formula 2$$

A_{8-pNA} Monooxygenase activity
ΔA absorbance per second [s⁻¹]
f₁ dilution factor of the enzyme in the cuvette: 19.86
f₂ conversion from 1/s→1/min, 60
1000 conversion factor from mmol/mL to μmol/mL
ε extincion coefficient, 13200 [M⁻¹ cm⁻¹]
d thickness of the cuvette, 1 [cm]

### Inhibition by CO

3 ml of the enzyme solution in closed flasks (in 12 mL Tris/HCl buffer, 1M NaCl) are inhibited by first removing the oxygen via nitrogen and then discharging CO into the medium for half an hour. Then, a test piece (4×6 cm) as described above (RH test) is added. The reaction is carried out in a water bath (37° C.) for 2 hours.

### XPS

X-ray Photoelectron Spectroscopy (XPS) involves irradiating a sample with X-rays of a characteristic energy and measuring the flux of electrons leaving the surface. With X-ray Photoelectron spectroscopy the composition and electronic state of the surface region of a sample can be studied.

### APPLICATION EXAMPLES

### Example 1

Polypropylene fabrics are cut into pieces of 4×6 cm and treated in 100 mL erlenmeyer flasks in 10 mL 30 mM Tris/HCl buffer, pH 7.5 solution containing 2 nM P450 from Bacillus megaterium BM-3 Wild type and mutant 139-3 produced in recombinant E. coli DH5 and 0.31 mM NADPH. After the enzyme treatment (30° C. for 10 h), the fabrics are washed with Na₂CO₃ (1 g/L, pH 9.5) for 2 hours and with distilled water for 1 hour. They are dried at 100° C. over night in a heat chamber. The rising height is determined as described above to be 3.7 cm for the mutant 139-3 and 0.8 cm for the wild type WT 18-6.

### Example 2

Polypropylene fabrics are cut into pieces of 4×6 cm and treated in 100 mL erlenmeyer flasks in 4.5 mL 30 mM Tris/HCl buffer, pH 7.5 solution containing 2 nM P450 from Bacillus megaterium BM-3 mutant 139-3 produced in recombinant E. coli DH5 and 0.31 mM NADPH. In parallel, controls are run using an enzyme inhibited with CO. After 5 hour of enzyme treatment, fabrics are washed with Na₂CO₃ (1 g/L, pH 9.5) for 2 hours und with distilled water for 1 hour. They are dried at 100° C. over night in a heat chamber. The rising height is determined as described above.

Results in table 1 clearly show that hydrophilisation is due to monooxygenase activity since CO inhibited enzymes do not show any effect.

TABLE 1
Enzymatic hydrophilisation of polypropylene using 2 nM P450 BM-3
from mutant 139-3 at different temperatures

| | RH_{10 min} 30° C. [cm] | RH_{10 min} 37° C. [cm] |
|---|---|---|
| Enzyme | 4.0 | 5.0 |
| Enzyme + CO | 0 | 0 |

### Example 3

Polypropylene fabrics are cut into pieces of 4×6 cm and treated in 100 mL erlenmeyer flasks in 4 mL 30 mM Tris/HCl buffer, pH 7.5 solution containing 2 nM P450 from Bacillus megaterium BM-3 mutant 139-3 produced in recombinant E. coli DH5 and 0.31 mM NADPH. After the enzyme treatment at 37° C., fabrics are washed with Na₂CO₃ (1 g/L, pH 9.5) for 2 hours und with distilled water for 1 hour. They are dried at 100° C. over night in a heat chamber. Rising height (RH) after 10 minutes and results of the drop test (DT) are determined as described above.

Results in table 2 show the dependence of incubation time on hydrophilisation of polypropylene at a constant enzyme concentration.

TABLE 2
Enzymatic hydrophilisation of polypropylene using 2 nM P450 BM-3
mutant 139-3 at different incubation times

| Incubation time [h] | RH_{2 min} [cm] | DT [s] |
|---|---|---|
| 2 | 3 | 4 |
| 5 | 3.8 | 2 |
| 10 | 4 | <1 |
| 15 | 4.1 | <1 |

### Example 4

Polypropylene fabrics are cut into pieces of 4×6 cm and treated in 100 mL erlenmeyer flasks in 30 mL 32 mM phosphate buffer solution pH 4.0 containing 15 mL enzyme preparation from Beauveria bassiana. After 10 hours of enzyme treatment at 37° C., fabrics are washed with Na₂CO₃ (1 g/L, pH 9.5) for 2 hours and with distilled water for 1 hour. They are dried at 100° C. over night in a heat chamber. The rising height determined as described above and is 4.8 cm.

1. A process for enhancing the hydrophilicity of a surface of a polyolefin or polyolefin copolymer article, wherein said process comprises contacting said surface with an enzyme selected from the group consisting of oxidoreductases, with the proviso that any steps leading to fixation of the oxidoreductases are excluded.

2. The process according to claim 1, wherein said oxidoreductases are obtained from the group consisting of natural bacterial whole cell preparations, modified stain bacterial whole cell preparations, fungal whole cell preparations, yeast whole cell preparations, plant whole cell preparations, mammalian whole cell preparations, cell lysates, extracts, and purified enzymes.

3. The process of claim 1, wherein the enzyme is selected from natural or modified monooxygenases.

4. The process according to claim 1, wherein the treatment with enzyme is carried out in the presence of water at a pH between 3 and 12 and in the temperature range 30-100° C.

5. The process according to claim 1, wherein the enzyme is used in an amount from 0.001 g to 10 g enzyme protein per kg of polymer material to be treated, or in an amount from 10⁻⁵ to 0.1 g of enzyme protein per square meter of surface to be treated.

6. The process of claim 1, wherein the surface material of the article comprises polyethylene or polypropylene or a copolymer comprising polyethylene and/or propylene repeating units.

7. The process of claim 1, wherein the surface material of the article comprises polypropylene or a copolymer comprising propylene repeating units.

8. The process of claim 1, wherein the article is a fibre, fabric, nonwoven, mono- or biaxially stretched film, or a moulded or extruded article.

9. The process according to claim 1, wherein the polyolefin or polyolefin copolymer contains one or more additives, fillers and/or finishing agents.

10. The process according to claim 1, wherein the surface is subjected to a washing step after the treatment with the enzyme.

11. The process according to claim 6, wherein the treated surface subsequently is subjected to one or more finishing steps by application of one or more suitable agents wherein said finishing steps are selected from the group consisting of dyeing, printing, imparting antimicrobial properties, imparting flame-retardant properties, and antistatic properties.

12. The process according to claim 6, wherein the enzyme is selected from the group consisting of cytochrome P450 family, enzymes classified as EC 1.13, enzymes classified as EC 1.14 and mixtures thereof.

13. The process according to claim 4, wherein the pH is between about 5 and about 9.

14. The process according to claim 9, wherein said additives, said fillers, and said finishing agents are selected from the group consisting of dyes, pigments, process stabilizers, ultraviolet light absorbers, hindered amine light stabilizers, further light stabilizers, antioxidants, processing aids, and surface modifiers.

15. The process according to claim 6 wherein the material is sanitary articles, threads, yarns, fabrics, textiles, garments, technical or household articles, printed or dyed cover films or packaging films.
